(19) United States
(12) Patent Application Publication
(10) Pub. No.: US 2009/0006976 A1
(43) Pub. Date: Jan. 1, 2009

(54) IMAGE FORMING APPARATUS TO TRANSMIT AND RECEIVE FILE INFORMATION USING RICH INTERNET APPLICATION (RIA), AND INFORMATION PROCESSING METHOD THEREOF

(75) Inventor: Jung-hyuck IM, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 12/134,338

(22) Filed: Jun. 6, 2008

(30) Foreign Application Priority Data
Jun. 29, 2007 (KR) 2007-65798

(51) Int. Cl. G06F 3/048

(52) U.S. Cl. 715/738

(57) ABSTRACT

An image forming apparatus provides information by using Rich Internet Application (RIA). The image forming apparatus is capable of directly transmitting and receiving file information to and from a web server. The image forming apparatus includes a storage unit to store a file, and a control unit to provide a User Interface (UI) to indicate web information stored in the web server and file information stored in the storage unit, and to perform download and upload of the web information and the file information on the UI according to a user selection. As a result, the file information is directly transmitted and received to and from the web server through a simple procedure.

### CROSS-REFERENCE TO RELATED APPLICATIONS

This application claims priority under 35 U.S.C. § 119 (a) from of Korean Patent Application No. 10-2007-0065798, filed on Jun. 29, 2007, in the Korean Intellectual Property Office, the disclosure of which is hereby incorporated herein in its entirety by reference.

### BACKGROUND OF THE INVENTION

1. Field of the Invention

The present general inventive concept relates to an image forming apparatus to transmit and receive file information using Rich Internet Application (RIA), and an information processing method thereof, and more particularly, to an image forming apparatus to transmit and receive file information to and from a web server using User Interface (UI) being provided according to the execution of RIA, and an information processing method thereof.

2. Description of the Related Art

An image forming apparatus, such as a printer or a Multi Function Peripheral (MFP), is connected with an information processing device such as a computer and outputs resultant data onto a sheet of paper. The image forming apparatus is generally used to receive a document or image data as data to print, converts the received data into printing language, and outputs the data onto the paper.

An image forming apparatus has continuously been updated, so that a network system is available, in which an image forming apparatus is provided in connection with a plurality of information processing devices and web servers. Such an updated type of the network system provides increased efficiency and utilization to an image forming apparatus, because it enables a plurality of users to share the image forming apparatus, and to thus save costs for additional image forming apparatus.

Meanwhile, Since the Internet has bee used to exchange information, the use of Internet is not limited to computer experts anymore, but it is rather a tool for millions of ordinary people to create valuable information within a short period of time.

User Interface Content (UCC) is content information created by individual users. The UCC is shared on the web. The users scan pictures or documents, create information, and log on to the web server to upload the created information. Users may also download information by searching images or text on the web server using a host device, and by transmitting the information to the image forming apparatus such that the information is printed, scanned, or faxed. However, all these upload or download procedures are not so convenient for the users.

Accordingly, it is necessary for an image forming apparatus to transmit and receive file information to and from a web server, to increase efficiency in a network system.

### SUMMARY OF THE INVENTION

The present general inventive concept provides an image forming apparatus to transmit and receive file information to and from a web server and other external device, using a User Interface (UI) being provided according to the execution of the Rich Internet Application (RIA), and an information processing method thereof.

Additional aspects and utilities of the present general inventive concept will be set forth in part in the description which follows and, in part, will be obvious from the description, or may be learned by practice of the general inventive concept.

The foregoing and other aspects and utilities of the present general inventive concept may be achieved by providing an image forming apparatus to directly transmit and receive file information to and from a web server, including a storage unit to store a file, and a control unit to provide a User Interface (UI) to indicate web information stored in the web server and file information stored in the storage unit, and to perform download and upload of web information and file information on the UI according to a user selection.

The image forming apparatus may further include a display unit to display the UI. The UI may include a first region to indicate the web information, a second region to indicate the file information, and a third region to indicate executable menus of the image forming apparatus.

If one piece of information is selected from among the web information and the file information, and when the selected piece of information is moved to one of the executable menus, the control unit processes the selected information according to the selected executable menu.

If one of the web information indicated on the UI is selected, and if a preview menu is selected, the control unit controls the UI to display details of the selected web information.

If a command to upload file information is input when connection is severed from the web server, the control unit causes file information for upload to be displayed on a previously received web site screen.

If connection with the web server is restored, the control unit provides a UI to select a target to be synchronized with.

If the UI to select a target to be synchronized with is displayed according to reconnection with the web server, and if the web server is selected from the displayed UI, the control unit attempts synchronization with the web server, and uploads to the web server the upload file information indicated on the previously received web site screen.

The image forming apparatus may further include an interface to communication with an external device, and if connected with the external device via the interface, the control unit is synchronized with the external device.

The user selection may implement a drag-and-drop method.

The control unit may create the UI by executing a previously installed RIA.

The foregoing and other aspects and utilities of the present general inventive concept may also be achieved by providing a method of processing information in an image forming apparatus to directly transmit and receive file information to and from a web server, the method including providing a User Interface (UI) to indicate web information stored in the web server and file information stored in the storage unit, and performing download and upload of web information and file information on the UI according to a user selection signal.

The UI may include a first region to indicate the web information, a second region to indicate the file information, and a third region to indicate executable menus of the image forming apparatus.

If one piece of information is selected from among the web information and the file information, and when the selected piece of information is moved to one of the executable menus, the providing of the UI may include processing the selected information according to the selected executable menu.

If one of the web information indicated on the UI is selected, and if a preview menu is selected, the performing of download and upload of web information and file information on the UI may include controlling the UI to display details of the selected web information.

The method of processing information may further include uploading to the web server the upload file information displayed on a site screen.

If a command to upload file information is input when connection is severed from the web server, the performing of download and upload of web information and file information on the UI may include displaying the file information to upload on a previously received web site screen.

The method of processing information may further include if connection with the web server is restored, providing a UI to select a target to be synchronized with, if the web server is selected on the provided UI, performing synchronization with the web server to determine whether the web server is connected with an external device, if connected with the external device, providing a UI to select a target to be synchronized with, and if the external device is selected on the provided UI, performing synchronization with the external device.

The user selection may implement a drag-and-drop method.

The providing of the User Interface (UI) may include downloading a Rich Internet Application (RIA) from the web server and installing the RIA, and executing the installed RIA and providing a UI to display web information stored in the web server and previously stored file information.

The foregoing and other aspects and utilities of the present general inventive concept may also be achieved by providing an image forming apparatus to transmit and receive file information to and from a web server, including a control unit to generate a user interface having a first region to indicate selection of web information and a second region to indicate selection of file information, and a storage unit to store the selections of the web information and file information if the user interface, wherein the control unit transmits information on the stored selections of the user interface to an external web server.

The control unit may download and upload the web information and the file information according to the information transmitted to the external web server.

The selection of the web information may include selection of a file of the second region to be transferred to the first region as the web information in the user interface.

The user interface may further include another region, and the selection of the web information may include selection of a file and an operation of the image forming apparatus in another region to be transferred to the first region as the web information in the user interface.

The selection of the file information may include selection of a file to be transferred to the second region as the file information in the user interface.

The user interface may further include another region, and the selection of the file information may include selection of a file and an operation of the image forming apparatus in another region to be transferred to the second region as the file information in the user interface

The control unit may transmit the information on the stored selections of the user interface to the external web server when the external web server is connected thereto.

The control unit may transmit the information on the stored selections of the user interface to the external web server through an external host device when the external web server is not connected and when the external host device is connected thereto.

The foregoing and other aspects and utilities of the present general inventive concept may also be achieved by providing an image forming apparatus to directly transmit and receive file information to and from a web server, including a storage unit to store a file, and a control unit to provide a user interface having a first region to indicate selection of web information stored in an external web server and a second region to indicate selection of file information of the file stored in the storage unit, and to store the selections of the user interface in the storage unit, and to communicate with the web server to transmit information on the stored selections and to perform download and upload of the web information and the file information of the first region and the second region on the user interface according to a user selection.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a block diagram illustrating an image forming apparatus according to an embodiment of the present general inventive concept;

FIGS. 2 to 5 are views illustrating a User Interface (UI) being provided by an image forming apparatus according to an embodiment of the present general inventive concept; and

FIG. 6 is a flowchart to explain an information processing method of an image forming apparatus according to an embodiment of the present general inventive concept.

Throughout the drawings, the same drawing reference numerals will be understood to refer to the same elements, features and/or structures.

### DETAILED DESCRIPTION OF THE PREFERRED EMBODIMENTS

Reference will now be made in detail to embodiments of the present general inventive concept, examples of which are illustrated in the accompanying drawings, wherein like reference numerals refer to the like elements throughout. The embodiments are described below in order to explain the present general inventive concept by referring to the figures.

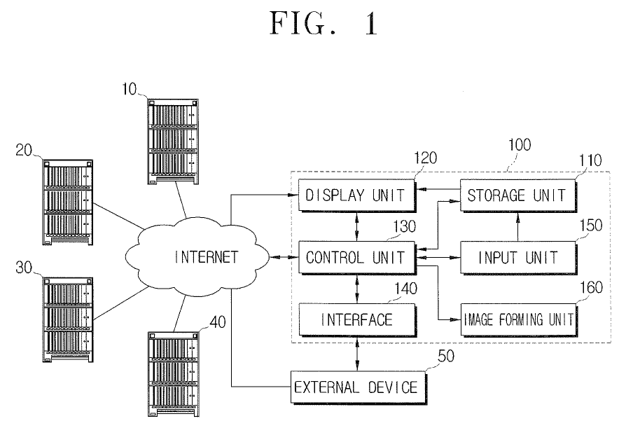

FIG. 1 is a block diagram illustrating an image forming apparatus 100 according to an embodiment of the present general inventive concept.

Referring to FIG. 1, the image forming apparatus 100 includes a storage unit 110, a display unit 120, a control unit 130, an interface unit 140, an input unit 150, and an image forming unit 160. The image forming apparatus 100 may be connected to a plurality of web servers 10, 20, 30, and 40 through a wired or wireless connection, for example, the Internet in a network. In this case, the image forming apparatus 100 may directly communicate with the web servers 10, 20, 30, and/or 40 to exchange data. The image forming apparatus 100 may also be connected to an external device 50, such as a personal computer (PC), through an interface 140. The image forming apparatus 100 and the external device 50 may be connected to each other through a wired or wireless connection in the network. In this case, the external device 50 is connected to the server 10, 20, 30, or 40 through the Internet to exchange data. Although FIG. 1 illustrates four web servers 10, 20, 30, 40, this is only for the illustrative purpose, and one will understand that the number of web servers should not be limited to four servers 10, 20, 30, 40.

The storage unit 110 stores files received from the external device 50, files directly downloaded from the web servers, and files directly written by a user using the input unit 150 and/or the display unit 120. The storage unit 110 may also store a Rich Internet Application (RIA) received from a corresponding one of the web servers 10, 20, 30, 40, and a runtime to perform the RIA.

The RIA is one of application programs to perform local application by using web techniques such as Flash, PDF, HTML, or AJAX. Unlike a conventional web operating manner that transmits and receives information based on a unit of web pages, the RIA requests the web server for information on source data, and constructs web information based on the requested information.

The RIA enables dynamic realization of a new screen, based on the source data previously created during the previous execution of the RIA. It is possible for a client to perform this dynamic realization of the new screen without requesting any information to the web server than the information on the source data.

The source data can be used to form a type of the web information, and the web information is downloaded and uploaded with respect to an interface of the RIA of the image forming apparatus 100. Here, the type of the web information may be a file of a photo, a file of a text, or a file of a combination of the photo and the text.

The RIA may be received from each of the web servers and installed. The RIA may be application programs such as User Created Content (UCC) RIA, and Word Processing (WP) RIA.

The UCC RIA may be an application to manage one or more user-created contents on the web such as a blog, a home page, a post board, a photo upload, or a video upload. The stored files of the storage unit 110 may be used as the user-created contents.

The control unit 130 generates a signal to provide a user interface (UI) to indicate the web information stored in the web server, and information about the file stored in the storage unit 110. The UI is created according to the execution of the RIA.

The display unit 120 displays the UI on a screen thereof. The display unit 120 may be provided on a panel of the image forming apparatus 100, and may be implemented as a LCD screen, or a touch screen to display the UI or to receive a user command to perform an image forming operation and an upload and download operation.

The UI includes a first region to display the web information, a second region to display the file information, and a third region to display one or more executable menus of the image forming apparatus 100. The UI may also include a cursor to move in or among the first, second, and third regions on the UI.

The control unit 130 may also provide the UI to select synchronization. The UI for synchronization may be provided in the form of a list indicating the web servers and/or the external device connectable to the image forming apparatus 100.

Accordingly, the storage unit 110 may store a list of names of the web servers 10, 20, 30, and 40 and/or the external device 50 to synchronize the web servers 10, 20, 30, and 40 and/or the external device 50 with the image forming apparatus 100 according to the stored RIAs. The web servers 10, 20, 30, and 40 or the external device 50 of the list may have the same RIA.

The control unit 130 may provide the UI by executing the RIA stored in the storage unit 110. In this case, downloading the web information, and uploading the file information may be performed through the provided UI. The web information upload through the UI may be performed, irrespective of connecting status with the internet of the web server.

Therefore, even when internet connection between the image forming apparatus 100 and the web server 10, 20, 30, or 40 is severed, the stored RIA can be driven to provide the UI, so that file information upload is carried out through the UI in an off-line mode.

That is, the web information to be downloaded and the file information to be uploaded can be selected thorough the UI, and the UI containing the selections can be stored in the storage unit 110 together with the RIA. Although the selections have been done through the UI, information on the selections is stored with the UI and the selections may not be performed when the image forming apparatus is not able to communicate with the web server 10, 20, 30, or 40 to perform the download and upload operation in the off-line.

Here, the upload and download of the information represent uploading and downloading of the information with respect to the UI, that is, from and to the UI of the RIA. For example, the information is uploaded, the information is uploaded to the UI of the RIA from a unit other that the UI, and the information is downloaded, the information is downloaded to the UI of the RIA from a unit other than the UI. The unit is referred to a component of the image forming apparatus 100 or the web server

Upon re-connection with the internet, the control unit 130 drives the RIA that uploads the file information of the UI formed in the off-line mode, so that the UI to select synchronization with a web server can be provided. As the user selects the web server, the selected web server is synchronized with the image forming apparatus 100, so that the previously formed upload and/or download items of the web and/or file information in the off-line mode can be performed automatically. Here, the synchronization represents that the image forming apparatus 100 and the server are synchronized with each other to exchange data according to the UI and the RIA.

If connection to the internet is not restored, the user may have the file information upload performed automatically, by selecting the external device 50 as a synchronization device. In this case, the external device 50 may receive the items of the UI from the image forming apparatus 100 and then automatically upload the created file received from the image forming to the previously connected web server, that is, automatically upload the created file to the web server which has now been disconnected from the image forming apparatus 100. The external device 50 may be synchronized with the image forming apparatus 100 and with the web server in transmitting and receiving data.

Meanwhile, the web information download and the file information upload may be selected by a drag-and-drop manner (operation) using a cursor displayed on a screen of the display unit 120. The cursor can move to perform the drag-and-drop operation according to a control of a button or a mouse of the input unit 150. In addition to the drag-and-drop operation using a cursor, other adequate methods may be employed to perform the web information download and the file information upload. For example, the web information download and the file information upload may be carried out by selecting corresponding files or functions using one or more direction keys and confirm key. Alternatively, the files and functions may be selected on a touch screen of the display unit 120.

The control unit 130 controls the image forming unit 160 to perform an image forming operation, for example, print, copy, scan, and fax, according to the UI or data or file received from an external device, for example, the external host device 50 or the external web server. A conventional image forming unit can be used as the image forming unit 160. The image forming unit 160 may include a unit or structure to perform an operation of the image forming apparatus 100 other than operations of the display unit 120 and the storage unit 110 of the image forming apparatus 100.

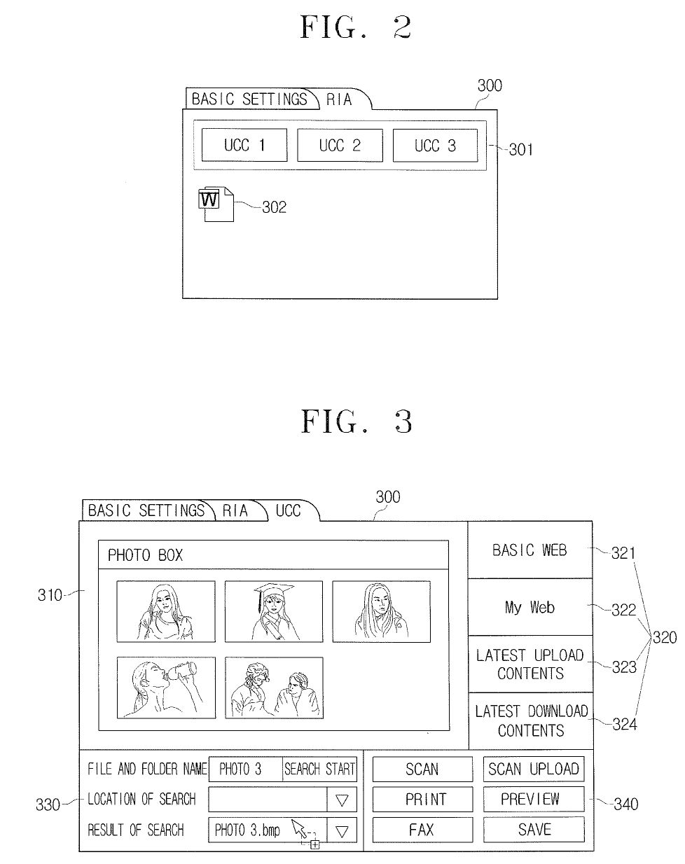

The operation of the control unit 130 of the image forming apparatus 100 of FIG. 1 to control the UI will be explained in greater detail below with reference to FIG. 2. FIGS. 2 to 5 are views illustrating a User Interface (UI) to be provided in an image forming apparatus according to an exemplary embodiment of the present general inventive concept.

Referring to FIGS. 1 through 5, the UI may be realized on an operation panel of the image forming apparatus 100. Under the control of the control unit 130, the UI provides one or more basic setting menus including print, copy, scan, and fax which are operations performed in the image forming unit 160 of FIG. 1, and one or more main menus for various options and submenus of the basic setting menus according to the selected options. A user may input a command to the UI on a touch screen panel of the display unit 120.

FIG. 2 illustrates a UI 300 that represents an RIA installed in the image forming apparatus 100 in the form of an icon. Referring to FIG. 2, when the RIA is selected from the UI 300, the UI 300 provides the RIA installed in the image forming apparatus as an icon. In the example illustrated in FIG. 2, the UI 300 categorizes types of the RIA into UCC RIA 301 such as icons of UCC1, UCC2, and UCC3, word processing RIA 302, or the like. The RIA is executed as a corresponding one of the icons is selected.

When the RIA is executed, connection is attempted to connect the image forming apparatus to the corresponding web server in the network. If the attempt to connect to the network is successful, the web information corresponding to the RIA is received from the web server and processed in the image forming apparatus. If the attempt for connection fails, that is, if there is no direct connection between the image forming apparatus and the corresponding web server, off-line processing may be performed using the previously stored web information. A job of the off-line processing may include uploading by the web server automatically, upon connecting to a network.

The “job” of the off-line processing refers to the creating of a web content by a user, which uploads file information such as posting articles, photos or moving picture to the corresponding web server associated with the RIA.

Download from the web server may be performed when a network is connected.

FIG. 3 illustrates an uploading operation. When the UCC RIA 301 is executed on an RIA main screen of the UI 300 of FIG. 2, a submenu screen of the UCC RIA 301 is displayed on the main screen of the UI 300 as illustrated in FIG. 3 to perform the uploading operation.

The UI 300 of FIG. 3 includes a first region 310 to indicate web information, a second region 330 to indicate file information searched by a search function, a third region 340 to indicate one or more executable menus of the image forming apparatus 100, a fourth region 320 to indicate one or more menus created by a user, and a cursor 360 movable on the UI. The fourth region 320 may include a menu (not illustrated) to select synchronization device to synchronize off-line operation.

Referring to FIG. 3, the web information is displayed in accordance with the UCC RIA being executed in the first region 310. An example explained below incorporates a blog as the UCC RIA.

If a user wants to upload a photo to a photo box of the first region 310, and if a file of the photo is stored in the storage unit 110, the user searches for the file in the second region 330, selects the file using an input unit to move a cursor, and moves the file to the first region 310 by drag-and-drop of the cursor. As a result, the selected file is uploaded to the first region 310.

If the storage unit 110 does not have a file to upload to the first region 310, a user may select a scan upload menu from among the executable menus of the third region 340. According to the executing of the scan upload menu, the desired photo is scanned and uploaded to the first region as the web information.

Meanwhile, a corresponding function may be executed, as a user uses the search function of the second region 330 and drag-and-drops the searched file to above one of the executable menus of the third region 340. For example, a printing operation is carried out, upon drag-and-dropping the searched file onto the printing menu. It is also possible to the web information from the first region 310 and drag-and-drop it to one of the executable menus of the third region 340. For example, if certain web information is dropped to the printing menu, the web information is downloaded and printed concurrently.

The fourth region 320 shows options menus that can be set by a user, including, a basic web 320 to indicate an index of a blog displayed in the first region 310, my web 322 such as a bookmark that can be designed by a user, a latest upload content 323 to indicate the contents uploaded recently, and a latest download content 324 to indicate the contents downloaded recently.

Accordingly, a file selected through the UI can be uploaded from the storage unit 110 or other units of the image forming apparatus and/or the web server to the first region of the UI as the web information, and a file selected through the UI can be downloaded from the first region of the UI to the storage unit 110 or other units of the image forming apparatus and/or the web server as the file information.

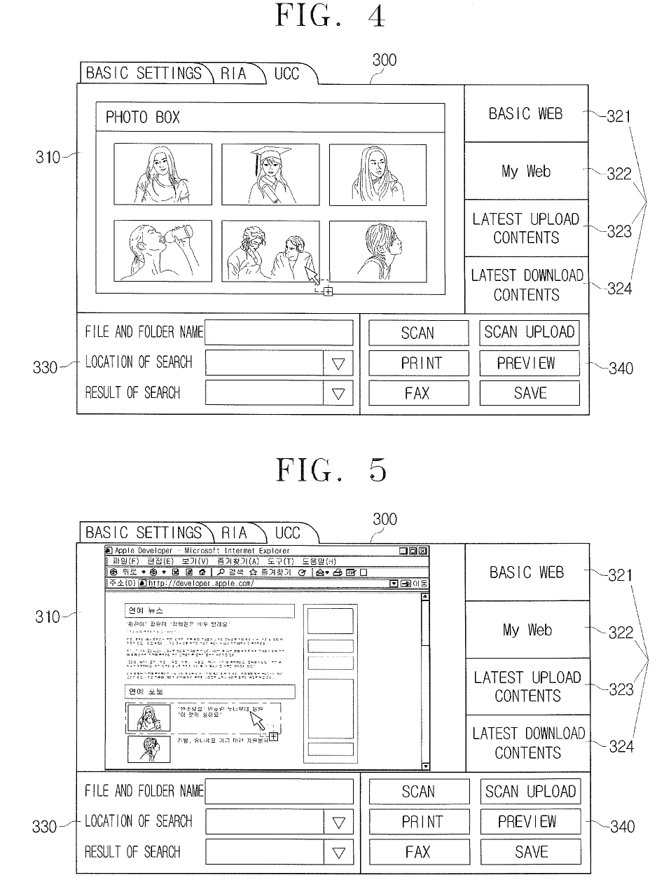

FIGS. 4 and 5 illustrate an upload process. As one piece of web information is selected by a cursor from the first region 310, and moved by drag-and-drop to one of the executable menus of the third region 340, the web information is downloaded from the UI and stored in the storage unit 110 along with the execution of the function of the selected menu. For example, the web information is printed and also stored in the storage unit 110, if it is moved to above the printing menu.

Referring to FIG. 5, the web information in association with a certain UCC is displayed in the first region. If a user wants to have a preview of web information that includes images and texts, and so he selects the web information and moves it to the preview menu of the third region, details of the selected web information are displayed. The details of the web information may be displayed in the form of popup window, or submenu screen on the UCC.

After that, the selected information is moved to one of the executable menus of the third region 340 and downloaded.

The control unit 130 may be implemented as a runtime to execute RIA. If a plurality of RIAs is implemented, the RIAs may each be operated according to corresponding runtimes selected by a user.

Although FIGS. 2 to 5 illustrate an example of file information upload and download via the RIA between the image forming apparatus 100 and the web server 10, 20, 30, 40, one will understand that this is not limiting. In another example, file information upload and download via RIA may be implemented between the image forming apparatus 100 and external device 50, and between external device 50 and the web server 10, 20, 30, 40. In both of the examples, it is desirable that the image forming apparatus, the external device, and the web server have the same RIA.

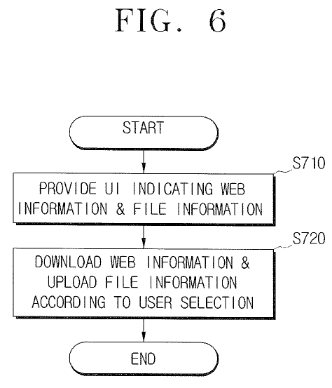

FIG. 6 is a flowchart to illustrate an information processing method of an image forming apparatus according to an exemplary embodiment of the present general inventive concept.

Referring to FIG. 6, RIA is downloaded from the web server and installed in an image forming apparatus which is directly connected with the web server via the Internet. Accordingly, at operation S701, a UI that indicates web information stored in the web server and previously stored file information, is provided through the executing of the installed RIA.

The UI displays a first region to indicate web information, a second region to indicate file information searched according to search function, a third region to indicate executable menus of the image forming apparatus 100, a fourth region to indicate menus created by a user, and a cursor movable on the UI.

At operation S720, web information download and file information upload indicated on the UI is performed according to user selection. The information may be downloaded or uploaded easily, by a drag-and-drop manner.

As one piece of web information or file information is selected by a cursor and moved to one of the executable menus of the third region, the selected information is processed according to the selected executable menu.

The executable menus of the third region may include print, scan, fax, scan upload, save, and preview.

Details of the selected web information may be displayed, by selecting with a cursor one of the web information from the first region, and a preview menu from the third region.

File information that the user intends to upload to the web server may be displayed in the first region, if the user attempts the upload of the file information to the web server in an off-line mode, and this file information is uploaded automatically later, upon connecting with the web server.

As the web server us reconnected, a UI is provided to synchronize with a corresponding web server. A list form of UI may be provided for the selection of synchronization.

Each RIA installed in the image forming apparatus stores lists of names of the web servers 10, 20, 30, 40 and external device 50 for synchronization. It is desirable that the web servers or external device included in the lists have the same RIA.

As a web server is selected through the UI provided for synchronization, off-line upload is performed automatically in synchronization with the selected web server.

If web server is not re-connected, the user may select the external device 50 as a synchronization device to perform file upload automatically. The external device 50 may automatically upload the off-line upload file to a corresponding web server upon reconnection. It is desirable that the external device 50 is in synchronization with the image forming apparatus 100 and the web server.

As a result, user is enabled to use off-line processing, and to transmit and receive file information to and from web server and external device through simple procedures.

As explained above, transmission and reception of file information is enabled between web server and external device, using a UI that employs Rich Internet Application (RIA).

User convenience also increases in the processing like information upload and download by use of drag-and-drop method.

Furthermore, user is enabled to process a job in an off-line mode even when connection is severed from the web server. The off-line job is then uploaded automatically through the synchronization process.

The present general inventive concept can also be embodied as computer-readable codes on a computer-readable medium. The computer-readable medium can include a computer-readable recording medium and a computer-readable transmission medium. The computer-readable recording medium is any data storage device that can store data as a program which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. An image forming apparatus to directly transmit and receive file information to and from a web server, comprising:
a storage unit to store a file; and
a control unit to provide a user interface to indicate web information stored in the web server and file information of the file stored in the storage unit, and to perform download and upload of the web information and the file information on the user interface according to a user selection.

2. The image forming apparatus of claim 1, further comprising
a display unit to display the user interface,
wherein the user interface comprises a first region to indicate the web information, a second region to indicate the file information, and a third region to indicate executable menus of the image forming apparatus.

3. The image forming apparatus of claim 2, wherein, if one piece of information is selected from among the web information and the file information, and when the selected piece of information is moved to one of the executable menus, the control unit processes the selected information according to the selected executable menu.

4. The image forming apparatus of claim 2, wherein, if one of the web information indicated on the user interface is selected, and if a preview menu is selected, the control unit controls the user interface to display details of the selected web information.

5. The image forming apparatus of claim 1, wherein, if a command to upload file information is input when connection is severed from the web server, the control unit causes file information for upload to be displayed on a previously received web site screen.

6. The image forming apparatus of claim 5, wherein, if connection with the web server is restored, the control unit provides the user interface to select a target to be synchronized with.

7. The image forming apparatus of claim 6, wherein, if the user interface to select a target to be synchronized with is displayed according to reconnection with the web server, and if the web server is selected from the displayed user interface, the control unit attempts synchronization with the web server, and uploads to the web server the upload file information indicated on the previously received web site screen.

8. The image forming apparatus of claim 1, further comprising:
an interface to communication with an external device,
wherein if connected with the external device via the interface, the control unit is synchronized with the external device.

9. The image forming apparatus of claim 1, wherein the user selection implements a drag-and-drop method.

10. The image forming apparatus of claim 1, wherein the control unit creates the user interface by executing a previously installed RIA.

11. A method of processing information in an image forming apparatus to directly transmit and receive file information to and from a web server, the method comprising:
providing a user interface to indicate web information stored in the web server and file information stored in the storage unit; and
performing download and upload of web information and file information on the user interface according to a user selection signal.

12. The method of claim 11, wherein the user interface comprises a first region to indicate the web information, a second region to indicate the file information, and a third region to indicate executable menus of the image forming apparatus.

13. The method of claim 12, wherein, if one piece of information is selected from among the web information and the file information, and when the selected piece of information is moved to one of the executable menus, the performing of the download and upload comprises processing the selected information according to the selected executable menu.

14. The method of claim 12, wherein, if one of the web information indicated on the user interface is selected, and if a preview menu is selected, the performing of the download and upload comprises controlling the user interface to display details of the selected web information.

15. The method of claim 11, further comprising:
uploading to the web server the upload file information displayed on a site screen.

16. The method of claim 15, wherein if a command to upload file information is input when connection is severed from the web server, the performing of the download and upload comprises displaying file information to upload on a previously received web site screen.

17. The method of claim 16, further comprising:
if connection with the web server is restored, providing the user interface to select a target to be synchronized with the web server;
if the web server is selected on the provided user interface, performing synchronization with the web server to determine whether the web server is connected with an external device;
if connected with the external device, providing the user interface to select a target to be synchronized with; and
if the external device is selected on the provided user interface, performing synchronization with the external device.

18. The method of claim 11, wherein the user selection implements a drag-and-drop method.

19. The method of claim 11, wherein the providing of the user interface comprises:
downloading an RIA from the web server and installing the RIA; and
executing the installed RIA and providing the user interface to display web information stored in the web server and previously stored file information.

20. An image forming apparatus to transmit and receive file information to and from a web server, comprising:
a control unit to generate a user interface having a first region to indicate selection of web information and a second region to indicate selection of file information; and
a storage unit to store the selections of the web information and file information if the user interface,
wherein the control unit transmits information on the stored selections of the user interface to an external web server.

21. The image forming apparatus of claim 20, wherein the control unit downloads and uploads the web information and the file information according to the information transmitted to the external web server.

22. The image forming apparatus of claim 20, wherein the selection of the web information comprises selection of a file of the second region to be transferred to the first region as the web information in the user interface.

23. The image forming apparatus of claim 20, wherein:
the user interface further comprises another region; and
the selection of the web information comprises selection of a file and an operation of the image forming apparatus in another region to be transferred to the first region as the web information in the user interface.

24. The image forming apparatus of claim 20, wherein the selection of the file information comprises selection of a file to be transferred to the second region as the file information in the user interface.

25. The image forming apparatus of claim 20, wherein:
the user interface further comprises another region; and
the selection of the file information comprises selection of a file and an operation of the image forming apparatus in another region to be transferred to the second region as the file information in the user interface.

26. The image forming apparatus of claim 20, wherein the control unit transmits the information on the stored selections of the user interface to the external web server when the external web server is connected thereto.

27. The image forming apparatus of claim 20, wherein the control unit transmits the information on the stored selections of the user interface to the external web server through an external host device when the external web server is not connected and when the external host device is connected thereto.

28. An image forming apparatus to directly transmit and receive file information to and from a web server, comprising:
a storage unit to store a file; and
a control unit to provide a user interface having a first region to indicate selection of web information stored in an external web server and a second region to indicate selection of file information of the file stored in the storage unit, and to store the selections of the user interface in the storage unit, and to communicate with the web server to transmit information on the stored selections and to perform download and upload of the web information and the file information of the first region and the second region on the user interface according to a user selection.
